(19) United States
(12) Patent Application Publication
(10) Pub. No.: US 2024/0317598 A1
(43) Pub. Date: Sep. 26, 2024

(54) OLEOPHILIC METAL SULFATE NANOMATERIALS AND HYDRATES THEREOF

(71) Applicants: Dong-Kyun Seo, Chandler, AZ (US); Le Phuong Tam Nguyen, Mesa, AZ (US)

(72) Inventors: Dong-Kyun Seo, Chandler, AZ (US); Le Phuong Tam Nguyen, Mesa, AZ (US)

(21) Appl. No.: 18/615,527

(22) Filed: Mar. 25, 2024

Related U.S. Application Data
(60) Provisional application No. 63/492,096, filed on Mar. 24, 2023.

(51) Int. Cl. C01F 11/46

(52) U.S. Cl. CPC C01F 11/46; C01P 2002/01; C01P 2002/72; C01P 2002/82; C01P 2002/85; C01P 2004/03; C01P 2004/04; C01P 2004/16; C01P 2006/19

(57) ABSTRACT

Preparing a functionalized alkaline earth metal nanomaterial or a hydrate thereof includes dissolving an alkaline earth metal salt in a first solvent to yield a first solution; combining a second solution including a transition metal sulfate, sulfuric acid, and a second solvent with the first solution to yield a first mixture; precipitating an alkaline earth metal sulfate nanomaterial from the first mixture, wherein the alkaline earth metal sulfate nanomaterial comprises a hydrous oxide of the transition metal on a surface of the alkaline earth metal sulfate nanomaterial; combining an organosilane and the first mixture to yield a second mixture; and reacting the organosilane and hydroxyl ligands on the hydrous oxide of the transition metal to yield the functionalized alkaline earth metal sulfate nanomaterial or the hydrate thereof. The resulting functionalized nanomaterial includes an alkaline earth metal sulfate or hydrate thereof with silyl groups bound to a surface of the nanomaterial.

### CROSS-REFERENCE TO RELATED APPLICATION

This application claims the benefit of U.S. Patent Application No. 63/492,096 filed on Mar. 24, 2023, which is incorporated by reference herein in its entirety.

### TECHNICAL FIELD

This invention relates to oleophilic metal sulfate nanomaterials and hydrates thereof, including methods of making the nanomaterials.

### BACKGROUND

Calcium sulfate, a naturally abundant and industrially important mineral, is found in nature often as fiber/needle-like crystals, in three distinct phases differing in their degree of hydration: gypsum (CaSO₄·2H₂O), bassanite (CaSO₄·0.5H₂O), and anhydrite (CaSO₄). Calcium sulfate dihydrate (CaSO₄·2H₂O) appears as gypsum mineral, the most abundant sulfate material on the Earth's surface. Calcium sulfate hemihydrate (CaSO₄·0.5 H₂O), known as “Plaster of Paris”, is found in the form of bassanite mineral, one of the most ubiquitous inorganic materials. Anhydrous calcium sulfate appears as anhydrite mineral, comprised of three sub-phases γ-CaSO₄ or AIII, β-CaSO₄ or AII, and α-CaSO₄ or AI.

### SUMMARY

This disclosure describes synthesis and functionalization of alkaline earth metal sulfate nanomaterials and hydrates thereof, as well as the resulting functionalized alkaline metal sulfate nanomaterials and hydrates thereof. The functionalized nanomaterials have improved oleophilicity relative to the unfunctionalized nanomaterials, as demonstrated by improved dispersibility in nonpolar organic media. As used herein, “oleophilic” or “hydrophobic” generally refers to an affinity for nonpolar organic media, or a tendency to repel polar media (e.g., water), respectively, while “oleophobic” or “hydrophilic” generally refers to a tendency to repel nonpolar organic media or an affinity for polar media (e.g., water). The functionalized nanomaterials can be used in a variety of applications, including polymer nanocomposites, rubber, plastics, antifriction materials and paper as a strengthening agent, for heat resistance, flame retardance, or creep resistance.

In a first general aspect, preparing a functionalized alkaline earth metal nanomaterial or a hydrate thereof includes dissolving an alkaline earth metal salt in a first solvent to yield a first solution; combining a second solution comprising a transition metal sulfate, sulfuric acid, and a second solvent with the first solution to yield a first mixture; precipitating an alkaline earth metal sulfate nanomaterial from the first mixture, wherein the alkaline earth metal sulfate nanomaterial comprises a hydrous oxide of the transition metal on a surface of the alkaline earth metal sulfate nanomaterial; combining an organosilane and the first mixture to yield a second mixture; and reacting the organosilane and hydroxyl ligands on the hydrous oxide of the transition metal to yield the functionalized alkaline earth metal sulfate nanomaterial or the hydrate thereof.

Implementations of the first general aspect may include one or more of the following features.

The nanomaterial can include nanoparticles, nanofibers, or both. The alkaline earth metal salt compound is typically a carbonate, such as calcium carbonate or barium carbonate. When the carbonate is calcium carbonate, the hydrate can be a bassanite. The transition metal sulfate can be a titanium sulfate (e.g., titanyl sulfate dihydrate). The hydrous oxide of the transition metal can include oxo, hydroxo, and aquo ligands of titanium dioxide. One example of a suitable organosilane is triethoxyphenyl silane. The first solvent, the second solvent, or both can be a polar organic solvent. In one example, the polar organic solvent is an alcohol (e.g., methanol).

Preparing the functionalized alkaline earth metal nanomaterial can occur in a single reaction vessel. Some implementations of the first general aspect include separating the functionalized alkaline earth metal sulfate nanomaterial or the hydrate thereof from the second mixture.

In a second general aspect, a functionalized nanomaterial includes a nanomaterial including an alkaline earth metal sulfate or hydrate thereof, with silyl groups bound to a surface of the nanomaterial. An oleophilicity of the functionalized nanomaterial exceeds an oleophilicity of the nanomaterial.

Implementations of the second general aspect may include one or more of the following features.

The nanomaterial can include nanoparticles, nanofibers, or both. Examples of suitable alkaline earth metals include calcium and barium. When the alkaline earth metal is calcium, the hydrate can be a bassanite. In one example, the silyl groups are triethoxyphenyl silyl groups. A width of the nanofibers is typically in a range of about 10 nm to about 100 nm.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts an overall procedure of a one-pot synthesis and functionalization of hybrid calcium sulfate-hydrous titanium oxide nanofibers with examples of the precursors.

FIG. 2 shows PXRD patterns of products prepared from CaCO₃ and TSD/H₂SO₄ mixture solution with different TSD/H₂SO₄ molar ratios.

FIG. 3 shows FTIR spectra of prepared samples in comparison with a mixture of α-HH and amorphous titanium dioxide powder as reference.

FIG. 4A shows Raman spectra of prepared samples in two regions: 980-1040 cm⁻¹ and 3480-3640 cm⁻¹. FIG. 4B shows XPS spectra. The intensity in the XPS spectra was scaled down by 1000 times.

FIG. 5 shows Raman spectra of prepared samples without functionalization. The region from 1300-2500 cm⁻¹ is not shown.

FIGS. 6A-6H show SEM images of samples prepared from different TSD/H₂SO₄ molar ratios. FIGS. 6A-6B show sample 0-1 from H₂SO₄; FIGS. 6C-6D show sample 1-20 from solution having molar ratio of TSD:H₂SO₄=1:20; FIGS. 6E-6F show sample 1-10 from solution having molar ratio of TSD:H₂SO₄=1:10, and FIGS. 6G-6H show sample 1-0 from TSD-MeOH solution.

FIGS. 7A-7D show TEM images of sample 0-1 from H₂SO₄. FIGS. 7E-7H show TEM images of sample 1-20 from solution having molar ratio of TSD:H₂SO₄=1:20, with HR-TEM microphotograph for each sample shown in FIGS. 7C and 7G and an FFT pattern corresponding to the reciprocal lattice revealed in FIGS. 7D and 7H. The zone axis is [010].

FIGS. 8A-8D TEM images of sample 1-10 from solution having molar ratio of TSD:H₂SO₄=1:10. FIGS. 8E-8H show TEM images of sample 1-0 from TSD-MeOH solution, with HR-TEM microphotograph for each sample shown in FIGS. 8C and 8G and an FFT pattern corresponding to the reciprocal lattice revealed in FIGS. 8D and 8H. The zone axis is [010].

FIG. 9 shows PXRD patterns of of functionalized products prepared from CaCO₃ and TSD/H₂SO₄ mixture solution and triethoxyphenyl silane (TEPS). The TSD/H₂SO₄ molar ratios were varied in these samples.

FIG. 10 shows powder X-ray diffraction (PXRD) patterns of Product in Example 1 and Products B2-B4 in Example 2. Simulated PXRD patterns of bassanite and anhydrite-II are also shown.

FIGS. 11A-11H show scanning electron micrographs of Products B1-B4 in Examples 1 and 2. FIGS. 11A and 11E correspond Product B1. FIGS. 11B and 11F correspond to Product B2. FIGS. 11C and 11G correspond to product B3. FIGS. 11D and 11H correspond to Product B4.

FIGS. 12A-12D show transmission electron micrographs of Product B4 in Example 2.

### DETAILED DESCRIPTION

This disclosure describes synthesis and functionalization of alkaline earth metal sulfate nanomaterials and hydrates thereof, as well as the resulting functionalized alkaline earth metal sulfate nanomaterials and hydrates thereof. The functionalization improves the oleophilicity or hydrophobicity of the nanomaterials. The surface functionalization process includes the preparation of a nanomaterial comprising a metal sulfate or its hydrate whose surface is covered with an inorganic compound comprising a transition metal. The nanomaterial is functionalized with a surface-modifying agent by contacting the nanomaterial with the surface-modifying agent in a reaction medium. The nanomaterial is collected from the reaction medium and can be dispersed in an organic medium.

Preparing a functionalized alkaline earth metal nanomaterial or a hydrate thereof includes dissolving an alkaline earth metal salt in a first solvent to yield a first solution. A second solution including a transition metal sulfate, sulfuric acid, and a second solvent is combined with the first solution to yield a first mixture. An alkaline earth metal sulfate nanomaterial is precipitated from the first mixture. The alkaline earth metal sulfate nanomaterial includes a hydrous oxide of the transition metal on a surface of the alkaline earth metal sulfate nanomaterial. An organosilane and the first mixture are combined to yield a second mixture. The organosilane and hydroxyl ligands on the hydrous oxide of the transition metal react to yield the functionalized alkaline earth metal sulfate nanomaterial or the hydrate thereof. The functionalized alkaline earth metal nanomaterial can be prepared in a single reaction vessel. In some cases, the functionalized alkaline earth metal sulfate nanomaterial or the hydrate thereof is separated from the second mixture and processed further (e.g., dried, combined with other materials, etc.).

The nanomaterial can include nanoparticles, nanofibers, or both. The alkaline earth metal salt compound is typically a carbonate, such as calcium carbonate or barium carbonate. When the carbonate is calcium carbonate, the hydrate can be a bassanite. The transition metal sulfate can be a titanium sulfate (e.g., titanyl sulfate dihydrate). The hydrous oxide of the transition metal can include oxo, hydroxo, and aquo ligands of titanium dioxide. One example of a suitable organosilane is triethoxyphenyl silane. The first solvent, the second solvent, or both can be a polar organic solvent. In one example, the polar organic solvent is an alcohol (e.g., methanol).

As described herein, a functionalized nanomaterial is a nanomaterial including an alkaline earth metal sulfate or hydrate thereof, with silyl groups bound to a surface of the nanomaterial. An oleophilicity of the functionalized nanomaterial exceeds an oleophilicity of the nanomaterial. In one example, the silyl groups are triethoxyphenyl silyl groups. The nanomaterial can include nanoparticles, nanofibers, or both. A width of the nanofibers is typically in a range of about 10 nm to about 100 nm.

In preparation of the nanomaterial, the metal sulfate or the hydrate may form together with the inorganic compound comprising the transition metal. In one example, calcium carbonate (CaCO₃) is reacted with a solution of TiOSO₄·2H₂O in methanol at room temperature to form bassanite (CaSO₄·0.5H₂O) and titania (TiO₂ or hydrous TiO₂), liberating CO₂ gas. In another example, barium carbonate (BaCO₃) is reacted with a solution of TiOSO₄·2H₂O in methanol at room temperature to form barite (BaSO₄) and titania (TiO₂ or hydrous TiO₂), liberating CO₂ gas. The nanomaterials are typically nanoparticles or nanofibers.

Functionalizing the nanomaterial includes contacting the nanomaterial with one or more surface-modifying agent, such as an organic group-containing compounds that are capable of adhering to a surface of the nanomaterial through chemical bonds, electrostatic interactions, or both.

One example includes synthesis and functionalization of calcium sulfate nanofibers all in one pot under ambient conditions, using methanol as a solvent. This is achieved by preparing calcium sulfate nanofibers having a surface decorated with hydrous titanium dioxide, using titanyl sulfate dihydrate (TiOSO₄·2H₂O, “TSD”) as precursor for the hydrous titanium dioxide. TSD dissolved in methanol at a high concentration up to ˜52 wt % under reflux conditions has a strong acidity due to the Brønsted acidity of TSD and also the presence of a small amount (˜12% in SO₄²⁻) of free sulfuric acid due to alcoholysis of the compound. The TSD solution in methanol thus also serves as a source for sulfate for the calcium sulfate nanofibers. By controlling the amount of TSD as the source of sulfate in the synthesis step, α-HH or β-CaSO₄ can be achieved as pure calcium sulfate phase in the product, including direct formation of β-CaSO₄ nanofibers via precipitation. The nanofibers are subsequently treated with an organosilane in the same reaction mixture, which react with hydrous titanium dioxide, imparting the desired hydrophobicity to the functionalized nanofibers. The functionalized nanofibers demonstrate good dispersibility in chloroform and benzene.

Functionalized nanomaterials from processes described herein have a variety of applications, including fillers or reinforcing materials in polymer nanocomposites, rubber, plastics, antifriction materials, and paper, and can act as a strengthening agent and impart heat resistance, flame retardance, creep resistance, or a combination thereof.

### Examples

Prior to all experiments, commercial titanyl sulfate dihydrate (“TSD”) powder (Sigma Aldrich, ≥29% Ti as TiO₂ basis, technical grade purity) was purified following known procedures. Briefly, 50 g of the powder was suspended in 400 mL of absolute ethanol (KOPTEC, 200 proof). The suspension was stirred for 1 hour, and a solid powder was collected by vacuum filtration. The powder was then washed with a copious amount of absolute ethanol three times, dried at 90° C. in a lab oven overnight, and stored in a sealed container. To make its solution in methanol (MeOH), the purified TSD powder was then added to MeOH (BDH, ≥99.8%) at a concentration of 158 g/L (corresponding to 20% w/w) in a 250 mL round-bottom flask. The mixture was magnetically stirred at 800 rpm, heating under reflux for 10 hours, which gave a clear colorless solution. The solution, denoted “TSD-MeOH” hereafter, was stored in a sealed container for further use.

TSD and calcite (CaCO₃, Sigma Aldrich, BioXtra≥99%) served as the sources for titanium and calcium, respectively, while both sulfuric acid and TSD provided sulfate ions. The nominal molar ratio of Ca/SO₄²⁻ was fixed at 1, while the relative amounts of TSD and sulfuric acid, the combined source for SO₄²⁻, were varied to provide four different products (Table 1). The sample names in Table 1 follow the ratio of TSD and sulfuric acid. For the synthesis, TSD-MeOH and sulfuric acid (H₂SO₄) were pre-mixed in appropriate amounts to give mixture solutions of TSD and sulfuric acid in methanol (Table 2). The mixture solutions were then added to CaCO₃ powder dispersed in MeOH. In the synthesis of Samples 1-10, for example, 0.450 mL of TSD-MeOH was mixed with 0.195 mL of concentrated H₂SO₄ in 10 mL of MeOH to form a homogeneous solution. The solution was then added dropwise to 0.4 g of CaCO₃ dispersed in 20 mL of MeOH in a round-bottom flask, which resulted in a white dispersion. The flask was sealed, and the mixture was stirred magnetically at 1600 RPM for 24 hours at room temperature. The solid product was collected by centrifugation and decanting the supernatant, followed by washing with a copious amount of MeOH. The final white wet product was stored in a closed plastic container for later characterization. A summary of reaction conditions for all samples is given in Table 2.

TABLE 1
Nominal ratios of the reactants and elemental analysis
data from XPS spectra for the eight products, with
and without the silane functionalization step

| | Nominal | | | | | |
|---|---|---|---|---|---|---|
| Sample | CaCO₃:TSD:H₂SO₄:TEPS | Elemental composition (at %) | | | | |
| name | mole ratios | Ca | S | O | Ti | Si |
| 0-1 | 1:0:1:0 | 19.34 | 18.76 | 61.89 | — | — |
| | | 1.00 | 0.97 | 3.20 | | |
| 1-20 | Theo. elemental comp. | 14.28 | 14.28 | 71.44 | | |
| | 21:1:20:0 | 18.55 | 22.86 | 58.38 | 0.21 | — |
| | | 1.00 | 1.23 | 3.15 | 0.01 | |
| 1-10 | Theo. elemental comp. | 13.91 | 13.91 | 71.52 | 0.66 | |
| | 11:1:10:0 | 25.32 | 17.97 | 56.02 | 0.69 | — |
| | | 1.00 | 0.71 | 2.21 | 0.03 | |
| 1-0 | Theo. elemental comp. | 13.58 | 13.58 | 71.60 | 1.23 | |
| | 1:1:0:0 | 14.59 | 15.60 | 64.32 | 5.49 | — |
| | | 1.00 | 1.07 | 4.41 | 0.38 | |
| | Theo. elemental comp. | 9.1 | 9.1 | 72.73 | 9.1 | |
| 0-1:S | 1:0:1:1 | 12.10 | 14.19 | 73.19 | — | 0.52 |
| | | 1.00 | 1.17 | 6.05 | | 0.04 |
| 1-20:S | 21:1:20:1 | 18.44 | 18.89 | 61.50 | 0.49 | 0.68 |
| | | 1.00 | 1.02 | 3.34 | 0.03 | 0.04 |
| 1-10:S | 11:1:10:1 | 18.87 | 18.31 | 61.78 | 0.40 | 0.64 |
| | | 1.00 | 0.98 | 3.28 | 0.02 | 0.03 |
| 1-0:S | 1:1:0:1 | 16.26 | 25.85 | 56.38 | 0.34 | 1.17 |
| | | 1.00 | 1.59 | 3.47 | 0.02 | 0.07 |

TABLE 2
Experimental conditions for all samples

| | | | TSD-MeOH | Conc. | |
|---|---|---|---|---|---|
| | Nominal | CaCO₃ | 20% | H₂SO₄ | |
| Sample | CaCO₃:TSD:H₂SO₄:TEPS | (in 20 mL | (in 5 mL of | (in 5 mL of | |
| name | mole ratios | of MeOH) | MeOH) | MeOH) | TEPS |
| 0-1 | 1:0:1:1 | 0.4 g | 0 | 0.214 mL | — |
| 1-10 | 11:1:10:1 | 0.4 g | 0.450 mL | 0.195 mL | — |
| 1-20 | 21:1:20:1 | 0.4 g | 0.236 mL | 0.204 mL | — |
| 1-0 | 1:1:0:1 | 0.4 g | 4.96 mL | 0 | — |
| 0-1:S | 1:0:1:1 | 0.4 g | 0 | 0.214 mL | 0.966 mL |
| 1-10:S | 11:1:10:1 | 0.4 g | 0.450 mL | 0.195 mL | 0.0876 mL |
| 1-20:S | 21:1:20:1 | 0.4 g | 0.236 mL | 0.204 mL | 0.0459 mL |
| 1-0:S | 1:1:0:1 | 0.4 g | 4.96 mL | 0 | 0.966 mL |

The silane-functionalized samples were produced by following the same procedure described above, except for an additional step at the end where triethoxylphenyl silane (“TEPS”, Gelest Inc., 97%), in the same molar amount to TSD, was added to the final white dispersion for the functionalization. Their sample names are given following the TSD:H₂SO₄ ratio with a suffix “:S”. In the synthesis of 1-10:S, for example, the 1-10 product was prepared by adding the 1:10 TSD/H₂SO₄ mixture solution to the CaCO₃ dispersion, as described above. After the completion of the stirring, however, the final white dispersion was not purified but the flask was unsealed and 0.0876 mL of TEPS was added to the reaction mixture. The flask was then re-sealed, and the reaction mixture was stirred for another 24 hours at room temperature. The product was collected by centrifugation, followed by washing with MeOH to remove excess reactants. The final white wet product was stored in a closed plastic container.

The dispersibility of the functionalized hybrid nanofibers was tested by using four solvents: methanol, acetone, chloroform, and benzene. These solvents were selected based on their relative polarity compared to water. In a typical test, a purified wet product was transferred into a small vial, and a pre-determined volume of the selected solvent was added, after which the mixture was sonicated to form a ˜1% w/w dispersion. The dispersions were kept undisturbed at room temperature and digital photographs of the dispersions were taken at the start and after 10 minutes. The ˜12% w/w dispersions of 1-20:S were also prepared in benzene and chloroform, following the same procedure.

Powder X-ray diffraction (PXRD) patterns of all samples were collected on a Bruker D2 Phaser powder X-ray diffractometer with a Cu Kα radiation wavelength of 1.5406 Å at a scan speed of 1 second/step and a step size of 0.02°. Scanning electron microscopy (SEM) images of selected samples were taken on a FIB Zeiss Auriga microscope operating at 5.0 kV acceleration voltage. Energy-dispersive X-ray data was performed on the same unit at 20 kV acceleration voltage. Transmission Electron Microscopy (TEM) images on selected samples were recorded on a FEI Titan 80-300 ETEM operating at 300 keV with a nanoprobe setting, spot size number 6. Wet products were dispersed in MeOH or CHCl₃ prior dropping on a holey carbon-copper grid.

Fourier transform infrared (FT-IR) spectra were collected on a Nicolet iS50 attenuated total reflection (ATR) FT-IR spectrometer manufactured by Thermo Scientific. The spectra were measured in a range from 400 to 4000 cm⁻¹ with a resolution of 0.482 cm⁻¹ per data point. Raman spectra were recorded on a custom-built spectrometer coupled to a microscope focused through a 50× lens and it uses a 523 nm laser as excitation source. The used grating were 600 lines/mm and 2400 lines/mm for wide scans and narrow scans, respectively. X-ray photoelectron spectra were performed on all samples using a Kratos Axis Supra+ photoelectron spectrometer with monochromatized A1 Kα excitation at pass energies of 80 eV for survey and 40 eV for high-resolution core-level spectra using the charge neutralizer. Analysis was performed on CasaXPS software (version 2.3.25).

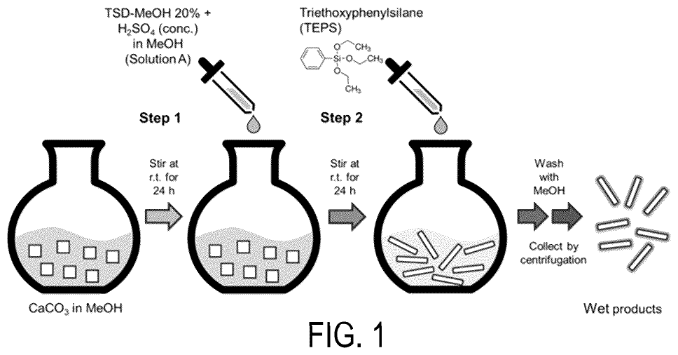

The overall experimental procedure is given schematically in FIG. 1, where the synthesis (Step 1) and functionalization (Step 2) of the hybrid calcium sulfate-hydrous titanium oxide nanofibers are carried out in one pot. In Step 1 (synthesis), CaCO₃ powder is first dispersed in MeOH. While the dispersion is stirred, a pre-determined amount of the solution A is added gradually to the dispersion and the mixture is stirred further for 24 hours at room temperature. The solution A is a concentrated H₂SO₄, TSD-MeOH or their mixture whose composition is given in Table 2. It is noted that the TSD-MeOH solution is highly acidic, due to the Brønsted acidic nature of TiOSO₄·2H₂O. The neutralization reaction of CaCO₃ with TSD and H₂SO₄ in the solution A produces precipitates of CaSO₄ or its hydrate and the hydrous TiO₂. The sample 1-0 corresponds to the reaction product only with TSD as the sulfate source, while 0-1 represents the one with H₂SO₄ as the sole sulfate source. The samples 1-20 and 1-10 were produced with both TSD and H₂SO₄ in the molar ratios of 1:20 and 1:10, respectively. The overall neutralization reaction during the process is the following:

$$Eq 1$$

$${CaCO}_{3} ( s ) + x {TiOSO}_{4} \cdot 2 {H}_{2} O ( soln ) + ( 1 - x ) {H}_{2} {SO}_{4} ( soln ) \to {CaSO}_{4} \cdot y {H}_{2} O ( s ) + x {TiO}_{2} \cdot z {H}_{2} O ( s ) + ( 1 + x - y - xz ) {H}_{2} O ( soln ) + {CO}_{2} ( g ) .$$

where x is determined by the precursor amounts (x=0 for 0-1; 0.047 for 1-20; 0.09 for 1-10; and 1 for 1-0), while y and z cannot be predetermined. The sample 0-1 (x=0) serves as a control which is prepared without TSD. The chemical formula for the hydrous TiO₂, TiO₂·zH₂O, represents only the stoichiometry, as the material would contain oxo, hydroxo, and aquo ligands at varied ratios, especially in its amorphous state. Ignoring the small amount of water in the concentrated H₂SO₄ and the methanol solvent, the total amount of H₂O molecules in the reaction container is 1+x per CaSO₄, after the neutralization, and in theory it is possible to see the formation of gypsum (CaSO₄·2H₂O; x=1, y=2, z=0), bassanite (CaSO₄·0.5H₂O; x=0-1, y=0.5, z=0-1.5) and anhydrite (CaSO₄; x=0-1, y=0, z=0-2). In other words, there is enough water to form even the gypsum, the most water-rich hydrate. However, the distribution of the water molecules is determined by how other components, e.g., the hydrous TiO₂ and the methanol solvent, would have their share of water molecules in the form of crystalline water and solvated water, respectively.

In Step 2 (functionalization), a predetermined amount of triethoxyphenyl silane is slowly added to the dispersion and the mixture is magnetically stirred for another 24 hours at room temperature. The amount of silane was to give the nominal Si/Ti molar ratio of 1 for all the functionalization reactions. The final product is collected by centrifugation and washed with copious amounts of MeOH to remove excess reactants and by-products. In the case where concentrated H₂SO₄ is the only source of sulfate (x=0), the amount of silane is adjusted to be equal to that of the acid. As mentioned above, because of the lack of hydroxo groups on the surface of CaSO₄, the triethoxyphenyl silane will not bond directly to the particles in the functionalization step even with an excess amount of silane. In the case where hydrous TiO₂ is present because of the addition of TSD, the organosilane reacts with the hydroxyl ligands on the surface of the hydrous TiO₂ embedded in CaSO₄, allowing the functionalization of the hybrid materials neatly in the same reaction container.

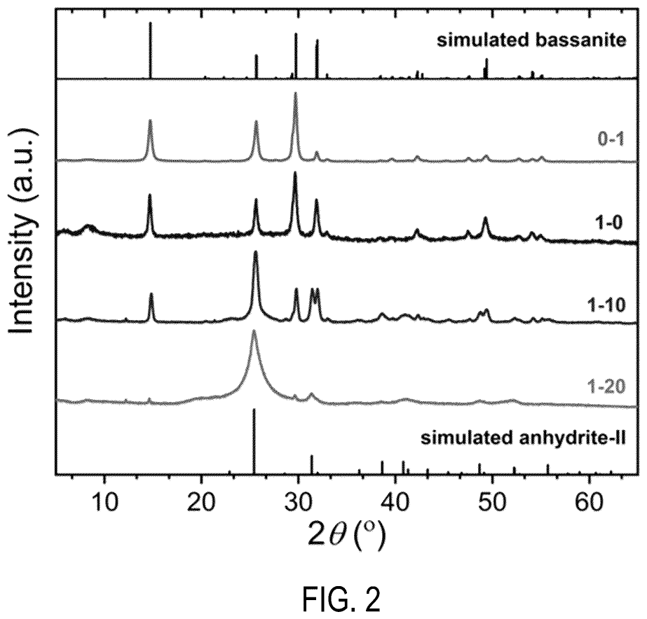

The PXRD patterns of the samples 0-1, 1-0, 1-10 and 1-20 are presented in FIG. 2. Overall, the PXRD patterns of 0-1, 1-0 and 1-10 are close to the simulated pattern of α-HH, while that of 1-20 resembles the simulated pattern of β-CaSO₄, indicating the influence of the TSD/H₂SO₄ ratio on the type of the products. The major peak of 1-20 is unusually broad, probably because of an appreciable degree of atomic disordering or considerable amounts of defects in the structure. Among 0-1, 1-0 and 1-10, both 0-1 and 1-0 have α-HH as the only calcium sulfate product, while 1-10 contains α-HH as well as B—CaSO₄. The quantification of the different calcium sulfate phases was not attempted for 1-10, because of the significant overlap of the major peaks and the discrepancies of the peak intensities with the theoretical patterns, probably due to the preferential orientations and imperfect crystallinities. The PXRD pattern of 0-1 shows a shoulder peak at 29.4° that can be assigned to CaCO₃, implying that the neutralization reaction was not complete. In contrast, the CaCO₃ shoulder peak is not apparent in the pattern of 1-0 and thus it might be said that the dissolved TSD reacts more efficiently with CaCO₃. It is noted that the pattern of 1-0 does not show the presence of hydrous titanium dioxide, which is understandable from the amorphous nature of the material. In essence, the increase in the relative amount of TSD improves the reaction completion and there are optimal ranges of the TSD/H₂SO₄ ratio for the formation of either α-HH or β-CaSO₄ as a pure phase.

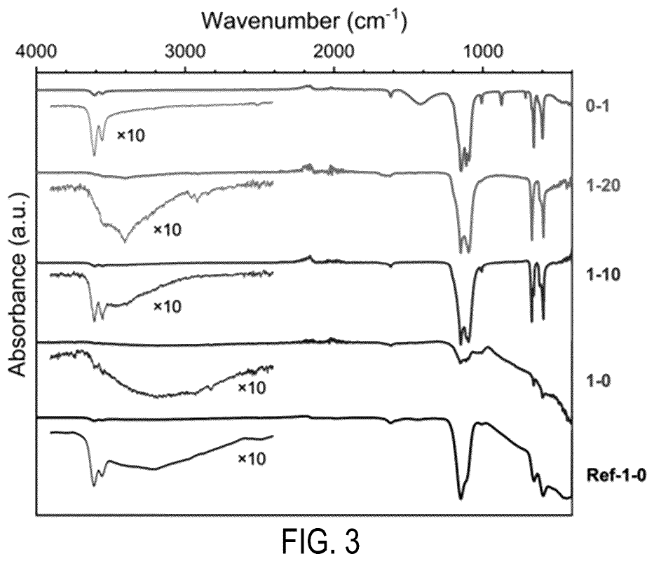

The product phases identified from the PXRD analysis are consistent with their ATR-FTIR spectra and peak assignments for the samples, shown in FIG. 3 and Table 3. First, the FTIR spectrum of 0-1 is identical to that of α-HH where the symmetric stretch modes of SO₄ of α-HH are located at 1146, 1111 and 1093, while the peaks at 659 and 601 cm⁻¹ belong to the asymmetric bend (v₄ SO₄). The peaks at 3610, 3556 and 1617 cm⁻¹ could be assigned to the O—H antisymmetric stretch (v₃ H₂O), O—H symmetric stretch (v₁ H₂O) and O—H bend (v₂ H₂O), respectively, of the water molecules in the structure of α-HH. For 1-20, however, those water vibrations do not appear in the spectrum of 1-20, as expected from the fact that it is 8-CaSO₄, based on the PXRD analysis. In addition, the peak positions at 670, 617 and 593 cm⁻¹ match well with reported values for 8-CaSO₄. Meanwhile, the co-presence of α-HH and β-CaSO₄ in 1-10 can be confirmed from its FTIR spectrum, as the absorption peaks of both phases are present in the spectrum. Finally, the analysis of the FTIR spectrum of 1-0 provides confirmation of the presence of α-HH (the peaks at 659 and 598 cm⁻¹ for vi SO₄ as well as 3609 and 3558 cm⁻¹ for O—H stretch in H₂O) and more importantly, implies the existence of hydrous TiO₂, which could not be validated by the PXRD analysis. Namely, the spectrum of 1-0 is very similar to that of a physical mixture (“Ref-1-0” in FIG. 3) of α-HH and amorphous titanium dioxide powder in approximately equal amounts. For example, both spectra have weak and broad features in 400-1000 cm⁻¹. The weak peaks at ˜410 cm⁻¹ in 1-0 and ˜ 430 cm⁻¹ in Ref-1-0 correspond to the energy of the Ti—O stretch. In addition, the very weak and broad peak in the 3000-3600 cm⁻¹ region is characteristic of the O—H stretch of surface hydroxo ligands.

TABLE 3
FTIR spectra of prepared samples

| | | | | | | ν₁ (H₂O) | ν₃ (H₂O) |
|---|---|---|---|---|---|---|---|
| | ν₄ (SO₄) | | ν₃ (SO₄) | | | O—H | O—H |
| | antisymmetric | | antisymmetric | | ν₂ (H₂O) | symmetric | antisymmetric |
| Sample | bending of SO₄ | | stretch | | O—H bending | stretching | stretching |
| Anhydrite-II | 594, 617 | 673 | 1097^{s} | ~1145^{ss} | | | |
| | (592, 609) | | (1095)^{s} | | | | |
| Anhydrite-III | 591, 610 | 672 | 1094^{s} | 1128 | | | |
| Bassanite | 601 | 659 | 1111^{s} | 1110, 1128, | 1617 | 3553 | 3605 |
| | | | | 1159 | | | |
| Gypsum | 595 | 667 | 1102^{s} | 1135^{u} | ~1619, 1682 | 3395 | 3489 |
| | | | | | (~1620, 1682) | (3403) | (3533) |
| 0-1 | 601 | 659 | 1111^{ss} | 1142^{s} | ~1620 | 3560 | 3610 |
| 1-0 | 597 | 659 | 1114^{ss} | 1149^{s} | ~1620 | 3556 | 3610 |
| 1-10 | 598^{b}, 620 | 659, | 1099^{s} | 1142^{ss} | ~1640^{b} | 3555 | 3610 |
| | | 671 | | | | | |
| 1-20 | 594^{b} | 667 | 1095^{s} | 1138^{ss} | ~1640^{b} | | |
| 0-1:S | 598 | 658 | 1110 | 1147 | ~1618 | 3556 | 3607 |
| 1-0:S | 600 | 657 | 1111 | 1144 | ~1618 | 3557 | 3608 |
| 1-10:S | 594, 617 | 659, | 1096 | 1148 | ~1610 | 3554 | 3607 |
| | | 671 | | | | | |
| 1-20:S | 593, 618 | 670 | 1097 | 1149 | ~1660 | | |

^{w}Weak peak
^{vw}Very weak
^{b}Broad peak
^{s}Strongest peak
^{ss}Strong, shoulder peak
^{u}Unclear in the spectrum

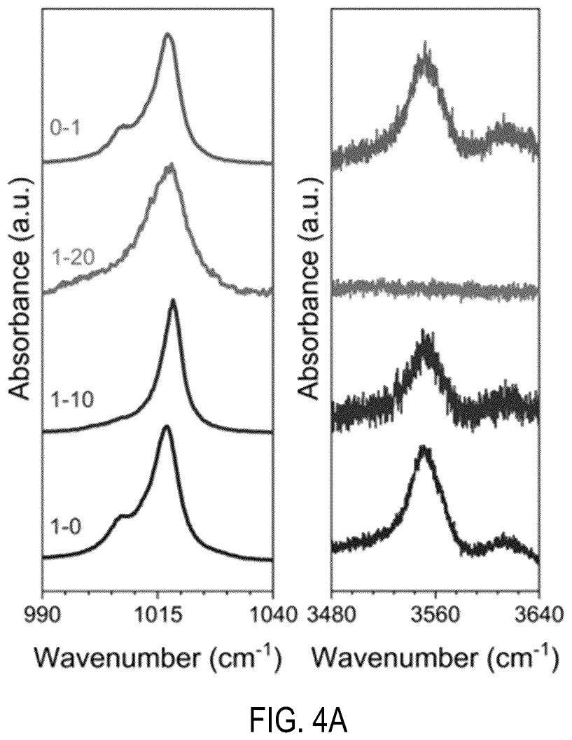

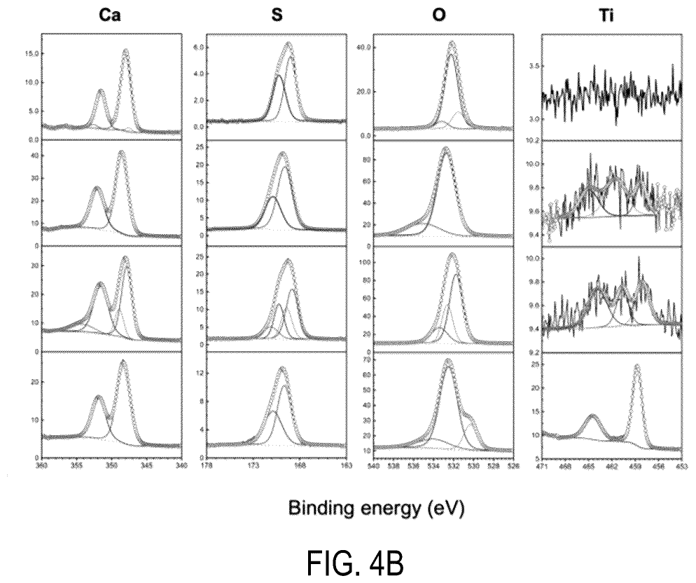

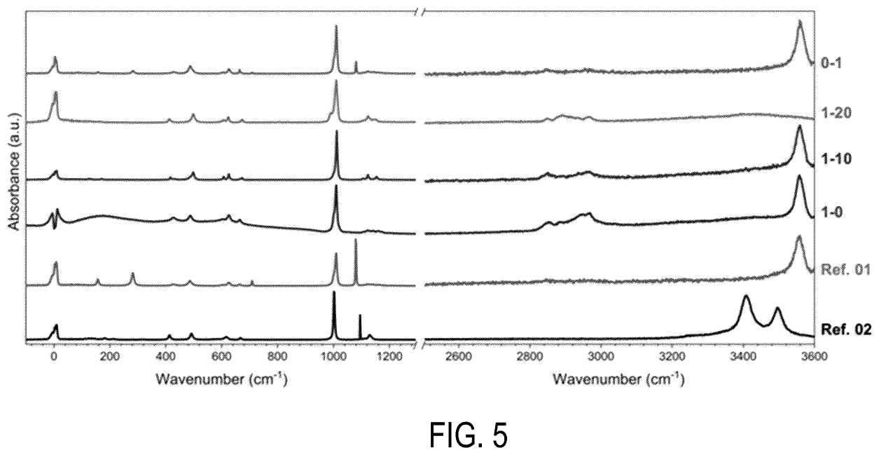

Raman spectroscopic studies on the samples corroborate the conclusions from the PXRD and FTIR analysis. FIG. 4A shows two spectral regions where the absorption takes place, while FIG. 5 and Table 4 show the full spectra and peak assignments, respectively. In 990-1040 cm⁻¹, the major peak appears between 1017 and 1018 cm⁻¹ and is assigned to a symmetric stretch of SO₄ (v₁ SO₄) for all the calcium sulfate phases. Its position at 1017 cm⁻¹ in 0-1 and 1-0 indicates the presence of α-HH, based on the comparison with the same peak position of the reference α-HH in FIG. 5 and Table 4, while 1-10 has it at 1018 cm⁻¹, consistent with its 8-CaSO₄ structure. The rather strong broadening of the peak in 1-20 hampers a firm conclusion but can be explained by the structural disordering/defects implied from its PXRD pattern. A weak peak is also present at ˜1008 cm⁻¹ in samples 0-1 and 1-0. This peak was previously assumed to belong to gypsum, yet there was no other evidence of the presence of gypsum in the samples, as it is excluded based on the PXRD and FTIR analysis. This could be an intrinsic part of the α-HH spectrum. In 3480-3640 cm⁻¹, the weak peak appears between 3551-3554 cm⁻¹ and is assigned to O—H stretch of H₂O (v H₂O) in 0-1, 1-10 and 1-0, which contains α-HH as pure phase or mixed phase.

TABLE 4
Raman spectra of prepared samples

| | ν₄ (SO₄) | | | | |
|---|---|---|---|---|---|
| | antisymmetric | | ν₁ (SO₄) | ν₃ (SO₄) | (H₂O) |
| Sample | bending | u | symmetric stretch | antisymmetric stretch | O—H stretch |
| Anhydrite-II | 609, 628, 675 | | 1017 | 1111, 1128, 1160 | |
| Anhydrite-III | 630, 673 | | 1026 | 1167 | |
| Bassanite | 627, 669 | | 1015 (1014) | 1128 | 3553 |
| Bassanite | | 1008^{w} | 1017 | | 3552 |
| Gypsum | 620, 673 | | 1008 | 1134 | 3401, 3491 |
| | | | 1009 | | 3396, 3493 |
| 0-1 | | 1008^{w} | 1017 | 1081, | 3551 |
| 1-0 | | 1007^{w} | 1017 | | 3551 |
| 1-10 | | 1007^{vw, b} | 1018 | 1105, 1123, 1155 | 3554 |
| 1-20 | 604^{w}, 6235^{s}, 670 | 1002^{vw, b} | 1018 | 1123^{w}, 1141^{w}, 1152^{w} | No peak |
| 0-1:S | 606, 626, 664 | 1008 | 1017 | 1081, 1124, 1153 | 3554 |
| 1-0:S | 604, 626, 664 | 1008 | 1016 | 1107, 1122, 1160 | 3550 |
| 1-10:S | 604, 624, 673 | 1000^{vw, b} | 1017 | 1081, 1125, 1152 | 3553 |
| 1-20:S | 604, 624, 673 | 1002^{vw, b} | 1018 | 1081, 1124, 1155 | No peak |

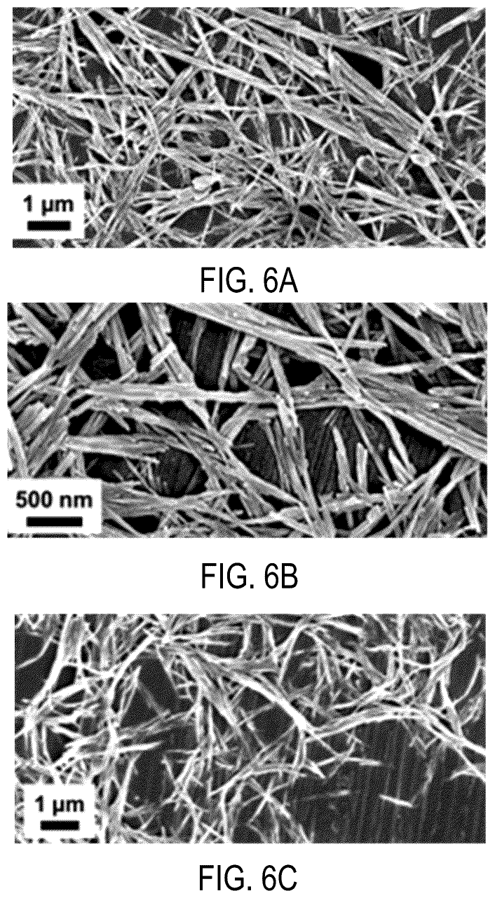

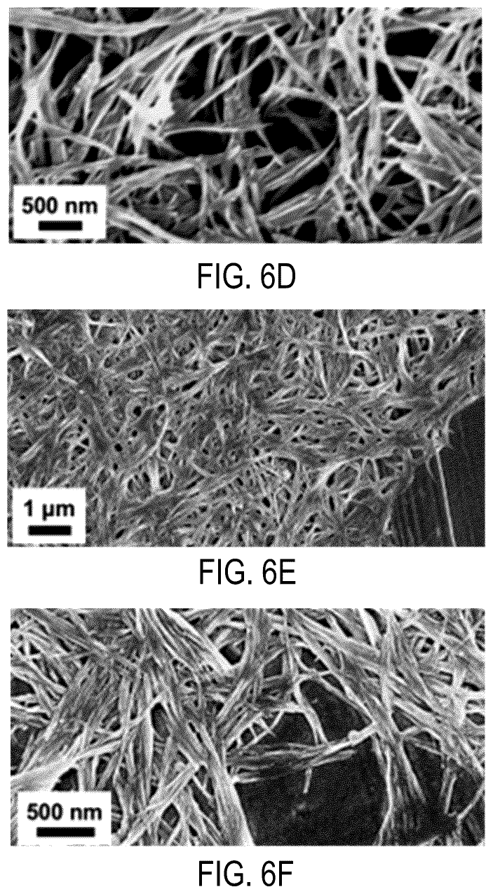

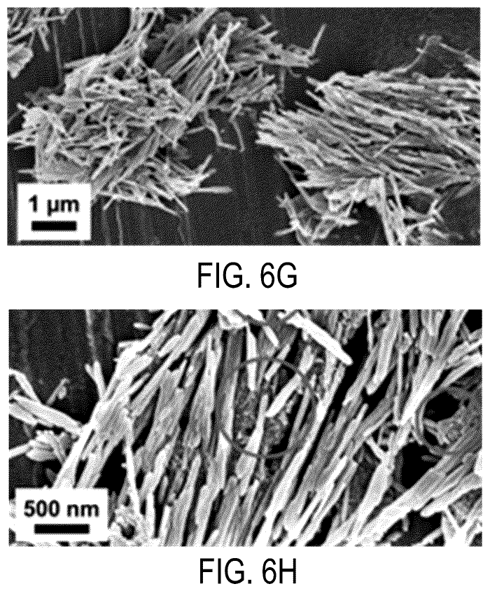

SEM images of the samples are shown FIGS. 6A-6H. Overall, the products exist as bundles of nanofibers that are several microns in length and less than 100 nm in diameter. The presence of α-HH in the nanofibrous from in 0-1 is observed in FIGS. 6A and 6B. Regarding 1-20 (FIGS. 6C and 6D), identified as pure β-CaSO₄ for the PXRD, the formation of the calcium sulfate phase as the nanofibers is unexpected and may be the first example of direct synthesis of B—CaSO₄ nanofibers. Although not shown, multiple areas of samples 1-20 prepared in different batches have been examined, and no apparent separate formation of hydrous TiO₂ was found. This could be because the small amount of TSD used for the synthesis or because it covers the nanofibers and cannot be visually distinguished from them. In any event, the formation of the 8-CaSO₄ nanofibers must have been influenced by the concomitant formation of the hydrous TiO₂ under our synthetic condition. In the SEM image of 1-10 in FIGS. 6E and 6F, nanofibers are intermingled together without discerning features, indicating that both α-HH or —CaSO₄ phases are formed similarly in shape and sizes in our synthesis. Meanwhile, the nanofibers in 1-0 (FIG. 6G) are observed to be bundled together in the SEM image. A closer look at the sample identifies regions, circled in FIG. 6H, where aggregated nanoparticles are observed. The EDS analysis confirms that they contain Ti exclusively, implying that the amount of TSD was in excess if we were to avoid separate formation of hydrous TiO₂.

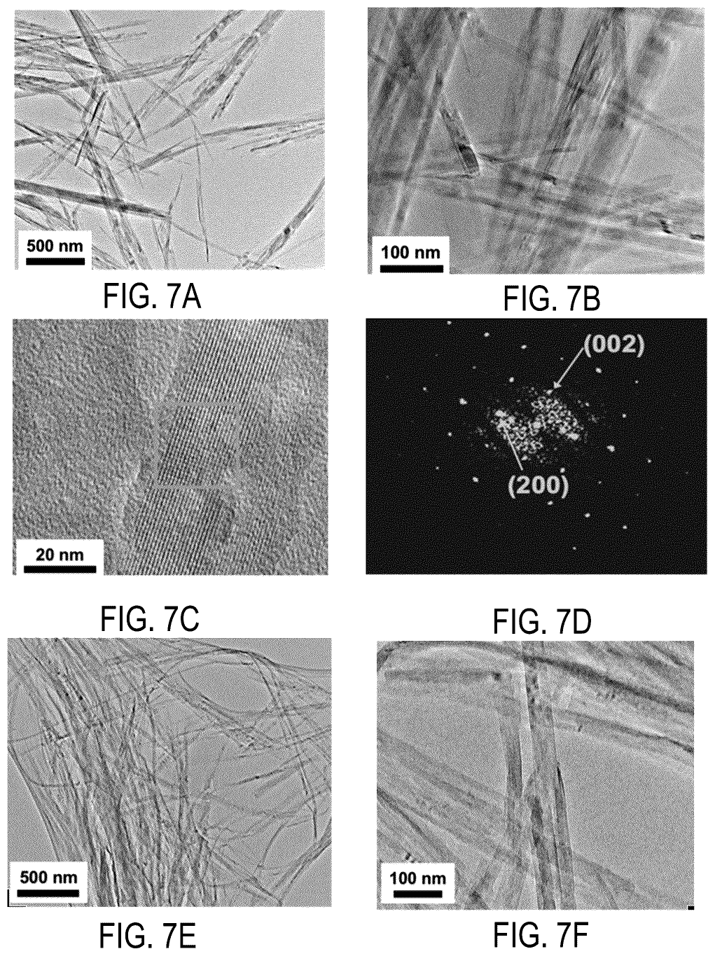

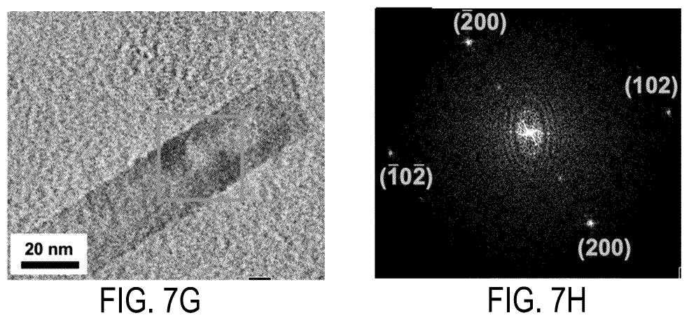

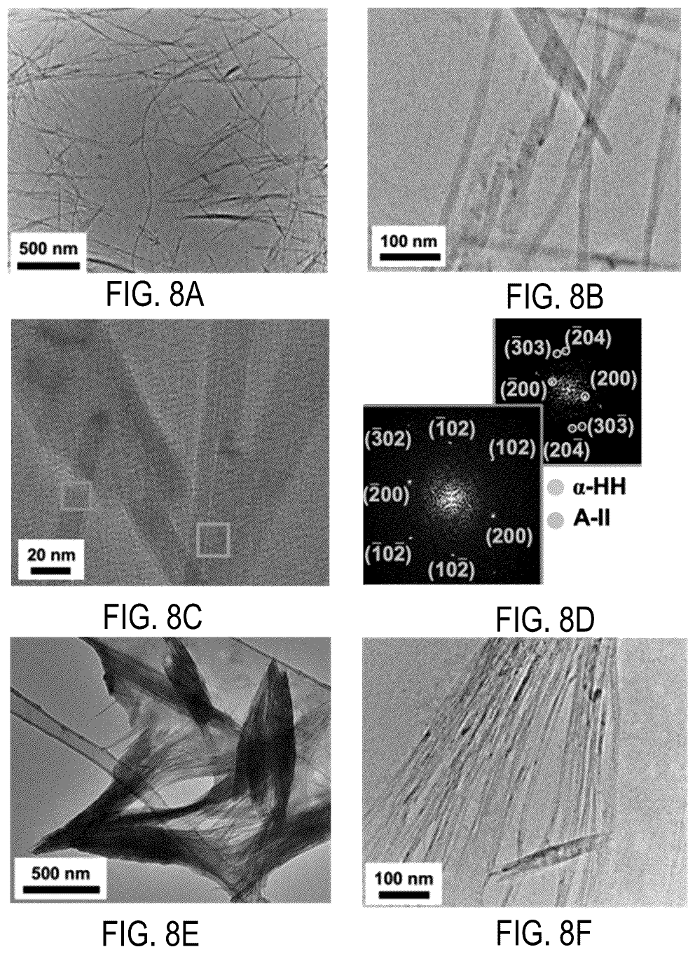

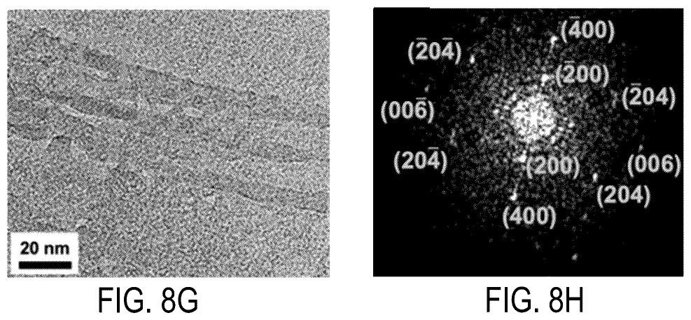

The details of the nanostructures of the samples were examined in the TEM studies and their representative TEM images are shown in FIGS. 7A-7H and FIGS. 8A-8H. All the samples were highly beam-sensitive and thus the images were obtained with the smallest probe size in the nanoprobe mode for which the focused beam diameter was reduced by increasing the convergence angle, to alleviate disintegration of the nanofibers during imaging. Nevertheless, the TEM studies allowed more precise estimations of the nanofiber diameters and could confirm the phase identifications in nanoscale. It is also notable that the nanofibers in 0-1, 1-20 and 1-10 could be separated into discrete objects (FIGS. 7A, 7E, and 8A) upon the 10 min-long ultrasonication during the TEM sample preparation, while the ones in 1-0 remained severely aggregated as bundles (FIG. 8E). When the nanofibers are compared at a higher magnification ratio (FIG. 7B for 0-1, FIG. 7F for 1-20, FIG. 8B for 1-10 and FIG. 8F for 1-0), it is clear that their diameters decrease as the amount of TSD increases in the reaction solution (Solution A in FIG. 1). In particular, the diameter of the nanofiber goes from 20-50 nm in 0-1 down to 10-15 nm in 1-0.

The growth directions of the nanofibers were identified by performing HRTEM. In FIG. 7C, the HRTEM micrograph of an α-HH nanofiber from 0-1 shows well visible lattice fringes in both longitudinal and transverse directions. Their spacings of 6.3 and 6.0 Å match well the door and d200 spacings in the crystal structure of α-HH, respectively. A small area of the nanofiber, shown with the green box in FIG. 7C, was chosen and its corresponding FFT in FIG. 7D clearly shows the a*c* lattice plane with prominent (002) and (200) reciprocal lattice points, based on their distances from the origin, conforming to the periodicities found in the lattice fringes. These observations indicate that the α-HH nanofibers in 0-1 grow along the c direction. For 1-20, the nanofiber in FIG. 7G does not exhibit well developed lattice fringes. However, the corresponding FFT from the blue-box region reveals the apparent periodicity with the reciprocal lattice points whose Miller indices give the zone axis (FIG. 7H). The orientation of the reciprocal lattice points implies that the β-CaSO₄ nanofibers in 1-20 also grow along the c direction. This analysis is consistent with the preferential orientation suggested from the unusual broad and strong major peak in its PXRD (FIG. 2). Due to the similar shapes and sizes of the α-HH and β-CaSO₄ nanofibers, the distinction between those in the HRTEM image of 1-10 (FIG. 7D) was possible only by a closer inspection of the lattice fringes or more preferably by the FFT patterns of the individual nanofibers. In FIG. 8D, the FFTs of the two different nanofibers (the boxes in FIG. 8C) disclose the reciprocal lattice points for the crystal structures of α-HH and ß—CaSO₄, respectively. Finally, the HRTEM micrograph of 1-0 (FIG. 7H) also confirms that the nanofiber product is α-HH. It is noted that the FFT pattern shows a*c* lattice plane like in the case of the 0-1 nanofiber, but the relative intensities among the reciprocal lattice points are much different between the two FFT patterns.

X-ray spectroscopy was employed to determine the elemental compositions of the samples, as well as the oxidation and chemical states of the atoms in the samples. In Table 1, the estimated elemental compositions are more or less in agreement with what is expected from the nominal ratios in the synthesis, although they do not exactly match. Namely, the amount of Ti in 1-20 is the smallest among 1-20, 1-10 and 1-0 samples, while that in 1-0 is significantly larger. It is noted that in all those samples, the Ti content is much less than the theoretical values from the mole ratios of the precursors for the samples, indicating that only a small portion of the Ti was incorporated in the final product.

High-resolution XPS spectra of Ca, S, O and Ti for the four samples are shown in FIG. 4B where the peaks are deconvoluted with the binding energies listed in Table 5. For 0-1, the deconvolution of the Ca and O peaks was carried out in consideration of the presence of the CaCO₃ impurity as found from the PXRD analysis (FIG. 2). In the top left panel in FIG. 4B, the CaCO₃ impurity caused a slight asymmetry in the Ca 2p_{3/2} and 2p_{1/2} peaks, and the peaks were deconvoluted by adding a small contribution from CaCO₃ (Ca 2p_{3/2} at 347.56 eV in Table 4). For other samples, the Ca spectra of 1-20 and 1-0 could be fitted with one Ca species, while 1-10 for which the spectrum was simulated best with two Ca species. The binding energies of the major Ca 2p_{3/2} peaks (Table 4) range from 347.84 to 348.91 eV in all samples and they fall in the range of reported values for Ca²⁺ in calcium sulfates. The small but appreciable discrepancies of the binding energies among the samples may be due to the nature of the different calcium sulfate phases or synthetic conditions but the exact origin is hard to trace. The presence of Ti atoms in the samples makes the situation even more complicated. In the high-resolution spectra of the S 2p region (the second column in FIG. 4B), the peaks could be deconvoluted into one S 2p_{3/2} and one S 2p_{1/2} peak for most samples, except 1-10. The result for 1-10 is understandable, given that the Ca 2p spectral region of the sample also indicates the presence of at least two different Ca²⁺ ion species. The binding energies of the S 2p_{3/2} peaks for the four samples range from 168.83 to 169.67 eV.

TABLE 5
Binding energies of elements in the samples

| | Binding Energy (eV) | | | | |
|---|---|---|---|---|---|
| Sample | Ca 2p_{3/2} | S 2p_{3/2} | O 1s | Ti 2p_{3/2} | Si |
| 0-1 | 347.97 | 169.03 | 532.16 | | |
| 1-20 | 348.54 | 169.61 | 532.73 | 458.24 | |
| | | | 535.05 | 461.49 | |
| 1-10 | 347.84 | 168.83 | 531.76 | 458.06 | |
| | 348.91 | 169.43 | 533.40 | 460.62 | |
| | | | 532.62 | | |
| 1-0 | 348.30 | 169.67 | 530.31 (TiO₂) | 458.75 | |
| | | | 532.50 | | |
| | | | 534.02 | | |
| 0-1:S | 348.15 | 169.34 | 532.32 | | 102.18 |
| 1-20:S | 348.03 | 169.17 | 532.17 | 457.43 | 102.45 |
| | | | 533.19 | 460.96 | 97.85 |
| 1-10:S | 348.03 | 169.25 | 532.21 | 458.45 | 102.3 |
| | | | 534.09 | | 97.14 |
| 1-0:S | 348.01 | 169.06 | 532.1 | 458.81 | 101.22 |
| | | | 532.83 | | |

For the high-resolution spectra of the O Is region (the third column in FIG. 4B), the peaks could be fitted well with two components for 1-20 and with three components for the other samples. For all samples, the major components have binding energies from 531.76 to 532.72 eV, which could be assigned to O²⁻ in SO₄²⁻ of calcium sulfate compounds. The binding energies of the minor components range from 533.40 to 535.05 eV, and could be attributed to the oxygen species from the carbon-tape substrate. For 0-1, the minor deconvoluted peak at 531.53 eV could be also from O²⁻ in the CaCO₃ impurity. The presence of hydrous TiO₂ in 1-0 is also clear from the high-resolution spectra of Ti 2p region (the bottom right panel in FIG. 4B) where the Ti 2p_{3/2} and Ti 2p_{1/2} peaks are prominent. For 1-20 and 1-10, those peaks are very weak and their deconvolution is not as meaningful for detailed analysis (the second and third panels in the right column of FIG. 4B). Nevertheless, the weak intensities and the positions of the peaks are consistent with the very small amounts of hydrous TiO₂ that is expected to exist in those samples, in contrast to the lack of such peaks for 0-1 (the top right panel in FIG. 4B).

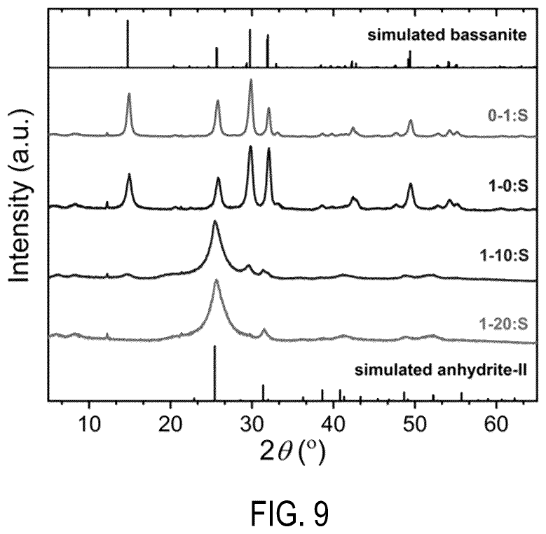

As aforementioned, the functionalization was carried out after the synthesis of the nanofibers, but in the same reaction medium (one-pot process). As such, the structural and morphological characteristics of the functionalized nanofibers are expected to be identical or very similar to those of the unfunctionalized ones. Indeed this is what can be concluded based on their PXRD patterns (FIG. 9) as well as SEM and TEM images. One notable observation in the PXRD patterns is that the functionalized nanofiber products exhibit the Bragg peaks that are generally broader than the unfunctionalized, indicating an appreciable degree of atomic disordering or considerable amounts of defects in their structure. This is particularly more pronounced when 1-10:S (FIG. 9) with 1-10 (FIG. 2) and also 1-20:S to 1-20. The morphologies of both functionalized and unfunctionalized nanofibers are quite similar, but the former, shown in SEM images, appears to be more strongly agglomerated after the same sonication process. This might indicate changes in surface properties after the functionalization, as expected. FT-IR, Raman and XPS spectroscopic studies were also carried out for the functionalized nanofiber products, mainly to identify/quantify the silane functional groups on the surface of the fibers from the different reactions. The presence of silane was clearly seen in the XPS spectrum of 1-0:S.

Nevertheless, the effect of the silane functionalization could be clearly seen from the different dispersion behaviors among the four functionalized nanofiber samples in different solvents. Overall, the functionalized nanofibers prepared with TSD disperse more effectively in nonpolar solvents, while the control sample, prepared without TSD (0-1:S), favors polar solvents. In particular, 1-20:S, 1-10:S and 1-0:S precipitate out partially or entirely in methanol and acetone, while 0-1:S shows a stable dispersion in methanol and is dispersible in acetone to some extent. In chloroform, they behave in the opposite ways; 0-1:S stays strongly aggregated, while 1-20:S, 1-10:S and 1-0:S are well dispersed in the solvent. The poor dispersibility of 0-1:S in chloroform must be due to the absence of TEPS on the nanofiber surface, which is understandable as the sample was prepared without TSD, hence lacking the hydrous TiO₂ decorating the surface.

Ultimately, the effect of the surface functionalization is most striking with benzene as the dispersing medium. The dispersions of 1-20:S and 1-10:S were transparent, showing a strong Tyndall effect. In fact, they remained transparent even after sitting overnight, although not shown here. In contrast, neither 0-1:S nor 1-0:S disperse well in benzene. The reason for the poor dispersibility of the former is the same as for the case of chloroform as a solvent. The poor dispersibility of the latter is somewhat unintuitive, as the sample was prepared with the largest amount of TSD. The surface functionalization of 1-0 nanofibers must have been less effective than that of 1-20 and 1-10, perhaps because the presence of a large amount of hydrous TiO₂ nanoparticles that coexist in the materials. Nonetheless, the stable dispersion of 1-20:S in both benzene and chloroform suggests that a small amount of TSD, as for 1-20:S, is sufficient for a good functionalization of the calcium sulfate nanofibers. Finally, it was observed that 1-20:S nanofibers could form a soft gel in benzene when the concentration is high (˜12 wt %). This unique characteristic is expected for highly-dispersible nanofibular materials such as cellulose nanofibers (CNF) in water or in glycols. On the other hand, the dispersion of 1-20:S in chloroform at the same concentration did not form a gel and precipitated out shortly after stopping ultrasonication. The superior dispersibility in benzene may reflect the fact that the TEPS covering the nanofiber surfaces has a benzene ring in its phenyl group.

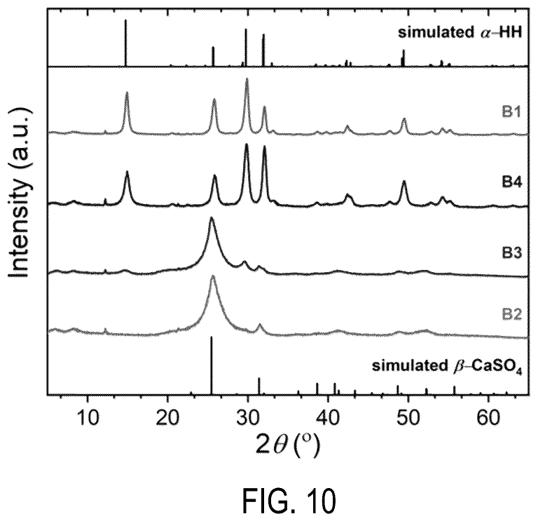

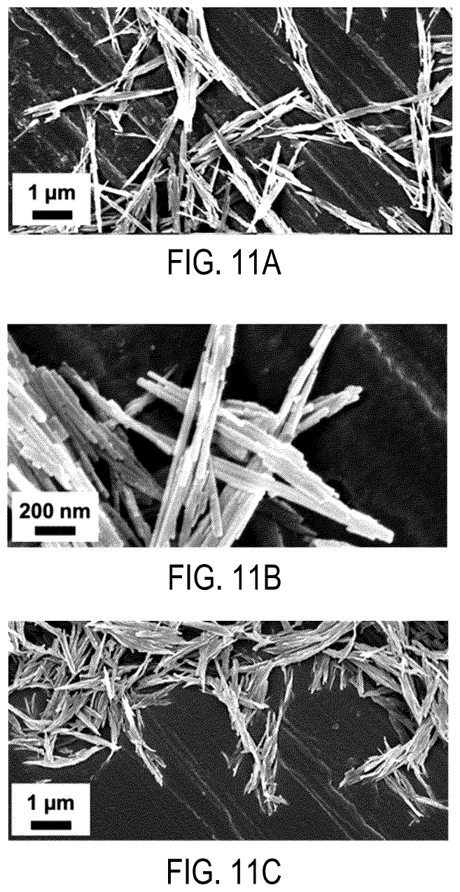

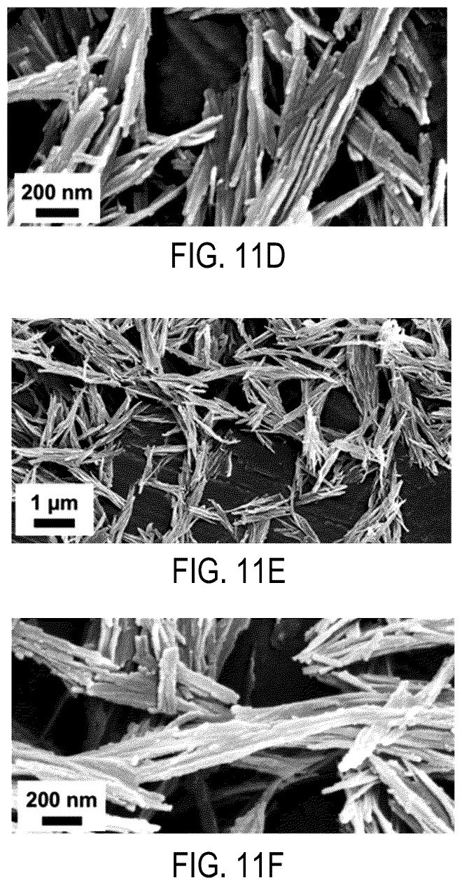

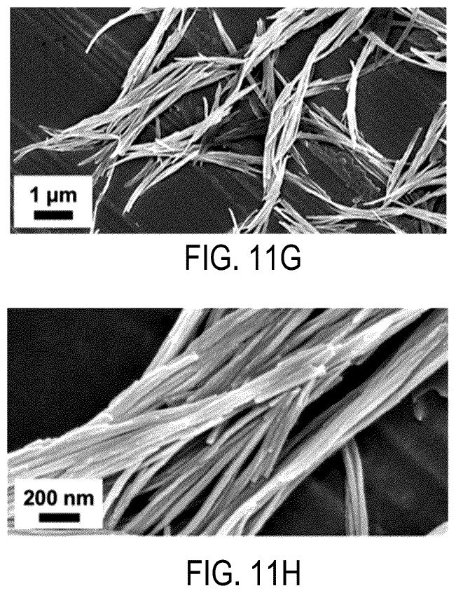

Example 1. This example is a reference synthesis without the presence of a transition metal compound. 0.4 g of calcium carbonate (CaCO₃) and 5 mL of methanol (MeOH) were added to a glass vial. Separately, a sulfuric acid solution in methanol was prepared by mixing 0.214 mL of concentrated H₂SO₄ with 5 mL of methanol. The sulfuric acid solution was added to the dispersion of CaCO₃ in methanol, while vigorously stirring. The nominal molar ratio of Ca²⁺/SO₄²⁻ was 1. Then the glass vial was sealed and the mixture was stirred vigorously for 24 hours at room temperature. After that, 0.0459 mL of triethoxyphenylsilane (TEPS) was added dropwise to the reaction mixture while constantly stirring. The glass vial was sealed and the mixture was left vigorously stirring for another 24 hours at room temperature. The product was collected by centrifugation, followed by washing with MeOH to remove excess reactants. The final white wet product was stored in a closed plastic container. A summary of the reaction condition for Product B1 is listed in Table 6. FIG. 10 shows the powder X-ray diffraction pattern of Product B1 which indicates the formation of bassanite as a crystalline phase. The scanning electron micrographs in FIGS. 11A and 11E show a nanofibular morphology of Product B1. It was observed that Product B1 does not show a good dispersibility in nonpolar solvents such as chloroform and benzene even after ultrasonication for 10 minutes.

TABLE 6
Summary of reaction conditions for Products B1-B4

| | Nominal | CaCO₃ | TSD-MeOH 20% | Conc. H₂SO₄ | |
|---|---|---|---|---|---|
| | TSD:H₂SO₄:CaCO₃:TEPS | (in 5 mL of | (in 5 mL of | (in 5 mL of | |
| Product | mole ratios | MeOH) | MeOH) | MeOH) | TEPS |
| B1 | 0:1:1:1 | 0.4 g | 0 | 0.214 mL | 0.0459 mL |
| B2 | 1:20:21:1 | 0.4 g | 0.236 mL | 0.204 mL | 0.0459 mL |
| B3 | 1:10:11:1 | 0.4 g | 0.450 mL | 0.195 mL | 0.0876 mL |
| B4 | 1:0:1:1 | 0.4 g | 4.96 mL | 0 | 0.966 mL |

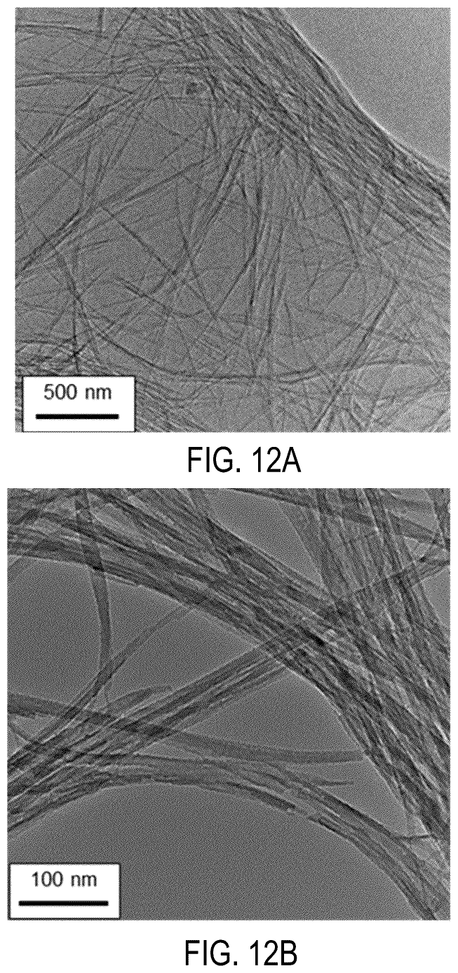

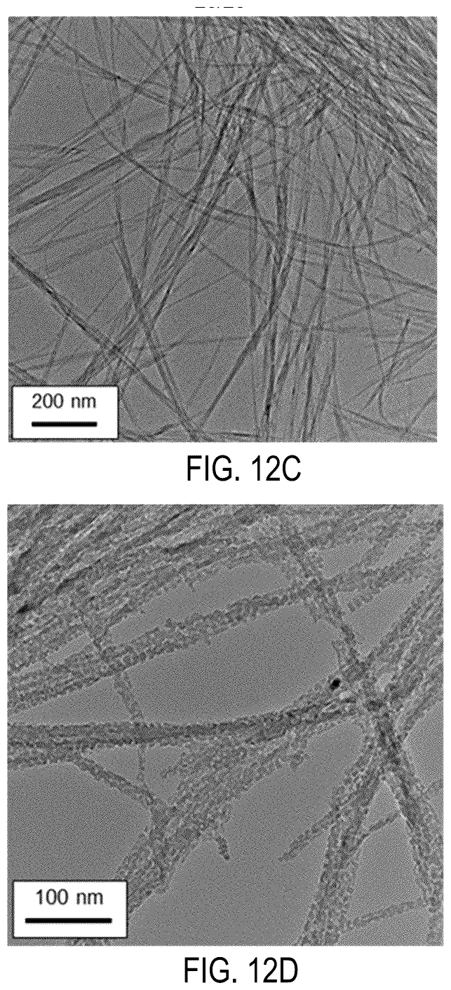

Example 2. Three products were prepared with a solution of titanyl sulfate dihydrate in methanol (“TSD-MeOH”), concentrated sulfuric acid, calcium carbonate (CaCO₃) and triethoxyphenyl silane (TEPS). The TSD-MeOH solution was prepared by adding of 1.581 g of titanyl sulfate dihydrate powder (TiOSO₄·2H₂O, “TSD”) to 10 mL of MeOH and subsequently heating under reflux for 10 hours. The concentration of the solution was 20 wt % TSD and the solution was stored in a closed plastic container. The three products were prepared by first adding homogeneous solutions of H₂SO₄ to the TSD-MeOH 20% (with different molar ratios of TSD/H₂SO₄, Products B2-B4 in Table 1) to CaCO₃, followed by adding TEPS to the reaction mixture. In a typical procedure, a certain amount of TSD-MeOH 20% solution was mixed with H₂SO₄ in methanol to form a homogeneous solution. The solution was then added dropwise to a stoichiometric amount of CaCO₃ powder dispersed in MeOH (the nominal molar ratio of Ca²⁺/SO₄²⁻=1). The glass vial was sealed and the mixture was stirred vigorously for 24 hours at room temperature. After that, a selected amount of TEPS was added dropwise to the reaction mixture while constantly stirring. The glass vial was sealed and the mixture was left vigorously stirring for another 24 hours at room temperature. The product was collected by centrifugation, followed by washing with MeOH to remove excess reactants. The final white wet product was stored in a closed plastic container. A summary of reaction conditions is listed in Table 6. FIG. 10 shows the powder X-ray diffraction patterns of Products B2-B4, which indicate the formation of bassanite as a crystalline phase. The patterns of Products B2 and B3 show a strong preferred orientation effect. The scanning electron micrographs in FIGS. 11B and 11F show nanofibular morphologies of Product B2. The scanning electron micrographs in FIGS. 11C and 11G show nanofibular morphologies of Product B3. Overall, the functionalized nanofibers prepared with TSD disperse more effectively in nonpolar solvents, while the control sample, prepared without TSD (Product B1), favors polar solvents. In particular, Products B2-B4 precipitate out partially or entirely in methanol and acetone, while in chloroform, Product B1 becomes strongly aggregated, and Products B2-B4 are well dispersed. The dispersions of Products B2 and B3 were transparent, showing a strong Tyndall effect. In addition, Product B2 nanofibers form a soft gel in benzene when the concentration is high (˜12 wt %). FIGS. 12A-12D show transmission electron micrographs of Product B4 where long nanofibers with an irregular surface texture are observed.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of preparing a functionalized alkaline earth metal nanomaterial or a hydrate thereof, the method comprising:
dissolving an alkaline earth metal salt in a first solvent to yield a first solution;
combining a second solution comprising a transition metal sulfate, sulfuric acid, and a second solvent with the first solution to yield a first mixture;
precipitating an alkaline earth metal sulfate nanomaterial from the first mixture, wherein the alkaline earth metal sulfate nanomaterial comprises a hydrous oxide of the transition metal on a surface of the alkaline earth metal sulfate nanomaterial;
combining an organosilane and the first mixture to yield a second mixture; and
reacting the organosilane and hydroxyl ligands on the hydrous oxide of the transition metal to yield the functionalized alkaline earth metal sulfate nanomaterial or the hydrate thereof.

2. The method of claim 1, wherein the alkaline earth metal salt compound comprises a carbonate.

3. The method of claim 2, wherein the carbonate comprises calcium carbonate or barium carbonate.

4. The method of claim 3, wherein the carbonate comprises calcium and the hydrate comprises a bassanite.

5. The method of claim 1, wherein the transition metal sulfate comprises a titanium sulfate.

6. The method of claim 5, wherein the titanium sulfate comprises titanyl sulfate dihydrate.

7. The method of claim 1, wherein the nanomaterial comprises nanoparticles, nanofibers, or both.

8. The method of claim 1, wherein the hydrous oxide of the transition metal comprises oxo, hydroxo, and aquo ligands of titanium dioxide.

9. The method of claim 1, wherein the organosilane comprises triethoxyphenyl silane.

10. The method of claim 1, further comprising separating the functionalized alkaline earth metal sulfate nanomaterial or the hydrate thereof from the second mixture.

11. The method of claim 1, wherein the first solvent, the second solvent, or both comprise a polar organic solvent.

12. The method of claim 11, wherein the polar organic solvent comprises an alcohol.

13. The method of claim 12, wherein the alcohol comprises methanol.

14. The method of claim 1, wherein preparing the functionalized alkaline earth metal nanomaterial occurs in a single reaction vessel.

15. A functionalized nanomaterial comprising:
a nanomaterial comprising an alkaline earth metal sulfate or hydrate thereof; and
silyl groups bound to a surface of the nanomaterial,
wherein an oleophilicity of the functionalized nanomaterial exceeds an oleophilicity of the nanomaterial.

16. The functionalized nanomaterial of claim 15, wherein the nanomaterial comprises nanoparticles, nanofibers, or both.

17. The functionalized nanomaterial of claim 16, wherein a width of the nanofibers is in a range of about 10 nm to about 100 nm.

18. The functionalized nanomaterial of claim 15, wherein the alkaline earth metal comprises calcium or barium.

19. The functionalized nanomaterial of claim 15, wherein the alkaline earth metal comprises calcium, and the hydrate comprises a bassanite.

20. The functionalized nanomaterial of claim 15, wherein the silyl groups comprise triethoxyphenyl silyl groups.
